(19) United States
(12) Patent Application Publication
(10) Pub. No.: US 2012/0038275 A1
(43) Pub. Date: Feb. 16, 2012

(54) METHOD FOR CHANGING THE STATUS OF LIGHT SEGMENTS IN A LIGHTING SYSTEM, LIGHT SEGMENT FOR THE LIGHTING SYSTEM, AND LIGHTING SYSTEM

(75) Inventors: Ulrich PÖHLER, Offenhausen (DE); Rainer PODSZUS, Neunkirchen (DE); Günther KÖNINGER, Nuemberg (DE); Ulrich MOHR, Steinbach (DE)

(73) Assignee: DIEHL AEROSPACE GMBH, Ueberlingen (DE)

(21) Appl. No.: 13/206,798

(22) Filed: Aug. 10, 2011

(30) Foreign Application Priority Data
Aug. 10, 2010 (DE) 10 2010 033 907.5

(51) Int. Cl. B60Q 3/00; H05B 37/02

(52) U.S. Cl. 315/77; 315/130

(57) ABSTRACT

The invention is based on the object of improving the installation and maintenance of lighting systems and of presenting a light segment and a lighting system which are adapted thereto in terms of design. This object is achieved by a method for changing the status of light segments 3 in a lighting system 1, the light segments 3 being connected to one another via a serial data connection 6, the status change comprising the following steps:
the serial data connection 6 is interrupted in or at the light segments 3;
an item of status change information is transmitted to a first light segment 3 I via the serial data connection 6;
the serial data connection 6 is restored in the first light segment 3 I;
an item of status change information is transmitted to a second light segment 3 II via the serial data connection.

### BACKGROUND OF THE INVENTION

The invention relates to a method for changing the status of light segments in a lighting system, the light segments being connected to one another via a serial data connection. The invention also relates to a light segment and to a or the lighting system.

### DISCUSSION OF THE PRIOR ART

In means of transport, for example trains, ships or else aircraft, lighting systems are used to light the interior for the passengers in a sufficient and comfortable manner. In the case of more modern installations, recourse is had to LEDs, that is to say light-emitting diodes, as luminous means in the lighting systems since they have a lower energy consumption, a longer life expectancy and a lower weight than conventional incandescent lamps. If multicoloured LEDs are used in such lighting systems, the light from the lighting system can even be varied with respect to the colour locus and the brightness. However, such colour effects can be implemented only if the LEDs can be selectively driven.

An architecture for driving LED systems is known, for example, from WO2009/011898A2 which is probably the closest prior art. The light system described in said document comprises a plurality of LED-based devices and a multiplicity of slave nodes for controlling the LED-based devices. The system also comprises a master node which is designed to control the slave nodes and thus to control the operation of the LEDs. In order to control the slave nodes, the system has a communication bus which serially connects the master node to the slave nodes. As emerges from the description, addresses or IDs are assigned to the slave node, with the result that the master node can selectively address the slave nodes.

### SUMMARY OF THE INVENTION

The invention is based on the object of improving the installation and maintenance of lighting systems and of presenting a light segment and a lighting system which are adapted thereto in terms of design. This object is achieved by a method having the features of Claim 1, by a light segment having the features of Claim 5 and by a lighting system having the features of Claim 9. Preferred or advantageous embodiments of the invention emerge from the subclaims, the following description and the accompanying figures.

One aspect of the invention relates to a method for changing the status of light segments in a lighting system. The lighting system is suitable and/or designed, in particular, for lighting the interior of a means of transport for passengers. The lighting system is particularly preferably a cabin or interior lighting system of an aircraft and is designed, in particular, to light the passenger compartment. The light segments may be arranged, for example, as so-called side wall and/or ceiling strip lights.

The light segments each comprise at least one LED (light-emitting diode). Alternatively, other light sources may also be used. The light segments have a data-processing connection to one another via a serial data connection. In possible embodiments, the lighting system comprises only one serial data connection to which all light segments are serially coupled. In other embodiments, the lighting system may also have a plurality of serial data connections which run parallel to one another and to each of which at least two, preferably at least, light segments are coupled for data-processing purposes. A structure of light segments which are coupled for data-processing purposes via a common serial data connection is also referred to as a light module below.

When changing the status of the light segments, the following steps are carried out: the serial data connection is first of all interrupted in the light segments. In particular, the serial data connection is interrupted in all light segments which are connected or can be currently reached via a common data connection. In the case of n light segments, n interruptions are therefore made in the serial data connection. The interruption is particularly preferably made using a broadcast message, that is to say a message in which data packets are transmitted from one point to all light segments of the serial data connection.

In a subsequent step, an item of status change information is transmitted to a first light segment via the serial data connection. In particular, the first light segment in the serial data connection is arranged such that it is directly adjacent to a control device which outputs the status change information. In particular, no other light segment or no other light segment containing status information is arranged between the control device and the first light segment. The status change information is preferably again transmitted as a broadcast message, that is to say a data message which is directed to all light segments.

In a next step, the serial data connection is restored in the first light segment. Restoring the serial data connection in the first light segment creates a signal path between the control device and the second light segment, with the result that an item of status change information is then transmitted to the second light segment via the serial data connection. Said steps are preferably iteratively repeated until all light segments of the serial data connection have received the status change information.

The advantage of the invention can be seen in the fact that, as a result of the serial restoration of the serial data connection, the individual light segments can be selectively supplied with an item of status change information which is, however, in the form of a broadcast message, that is to say a message directed to all light segments.

The advantages of the invention are particularly clear if the status change involves addressing, that is to say passing an address or an ID or an identifier, also referred to as an address in summary below, to, the light segments. In order to make it possible to selectively drive the light segments during operation, the control device must be able to selectively address the light segments, for example via a unicast message which is selectively directed to one address and thus to one light segment. This requires an address to be assigned to each light segment.

The address has hitherto been assigned during final assembly in the production of the light segment or when assembling the lighting system. This operation had to be repeated during every repair or reconfiguration. Since the addresses have hitherto been manually allocated, this operation was time-consuming and thus also cost-intensive.

The method according to the invention makes it possible to automate the assignment of the addresses, which requires considerably less time and thus signifies reduced costs. In addition, possible operating errors by the personnel can also be eliminated.

After the status change information has been received, it is possible in principle for the light segment to fetch its address from the control device (polling). However, it is preferred for the transmission of the status change information to correspond to transmission of an item of address information to the respective light segment, the light segment setting its own address, in response to the reception of the address information, on the basis of the address information in the light segment. In the simplest embodiment, the address is transmitted as the status change information, the light segment receiving said address and setting it as its own address.

In one preferred development of the invention, the first light segment outputs, via the serial data connection, an item of confirmation information, in particular acknowledgement information, which indicates that the address has been registered in the light segment. In addition, the first light segment may optionally also output further information, for example technical data or a light segment identification with respect to its own technical equipment.

In particular, provision is made for a light segment which has received an item of status change information and has optionally additionally implemented the status change information, in particular has received an address and has set the address, to ignore and/or passively forward further status change information.

A first possible refinement of the invention may provide for setting, in the control device, how many light segments are coupled in the serial data connection. This method alternative is appropriate if the number of light segments is present as pre-existing knowledge or a-priori knowledge with respect to the number of light segments. The method is then ended as soon as the corresponding number of light segments has returned the confirmation information.

Another embodiment of the invention provides for the method to be ended as soon as no confirmation information is returned after the status change information, in particular the address information, has been transmitted. In this case, all light segments coupled to the serial data connection have received such an item of status change information and have, in particular, set the address, with the result that they do not return any confirmation information. The lack of confirmation information is therefore deemed to be information stating that all light segments have been dealt with. Another aspect of the invention relates to a light segment which is, in particular, in the form of an aircraft interior lighting system and is preferably suitable and/or designed for carrying out the method which has just been described or rather the method in the preceding claims. The light segment comprises some LEDs (light-emitting diodes) for lighting the aircraft interior. The light segment preferably has differently coloured LEDs, in particular red, green, blue and white LEDs.

The light segment has a slave unit which can be assigned an item of status information. In particular, the slave unit may be assigned an address. The light segment also comprises an interface for a serial data connection, in particular for the serial data connection as was described above.

As an adaptation according to the invention, the light segment comprises an interruption device, the slave unit being designed to switch the interruption device, for example after receiving an item of status change information via the interface. This makes it possible for the light segment to first of all interrupt the serial data connection using the interruption device, to then receive an item of status change information and to retain it as status information and to then restore the serial data connection, with the result that data packets or messages on the serial data connection can be looped through the slave unit.

In this case too, it is preferred for the status information to represent an address of the light segment. The slave unit is particularly preferably designed to drive the LEDs of the light segment in such a manner that colour effects, for example light patterns such as rainbows or flag colours, are produced. Changes in the colour locus, the brightness and the colour temperature are also suitable as colour effects.

In one preferred design refinement of the invention, the interruption device is in the form of a switching element, in particular a MOSFET transistor. The MOSFET transistor is particularly preferably selected in such a manner that it has a very low RDSON resistance with a simultaneously low gate charge capacitance in order to avoid considerably corrupting data transfers over a plurality of light segments.

In one possible development of the invention, the light segment has a monitor device which is designed to check the serial data connection, the monitor device being arranged downstream of the interruption device in terms of signalling in the serial data connection. This monitor device makes it possible for the slave unit to automatically check the switching state of the interruption device. If the interruption device is open, the monitor device cannot receive any signals from the serial data connection, for example a BUS_Monitor signal. As soon as the interruption device is closed, the functionality of the interruption device can be monitored via the monitor device.

Another aspect of the invention relates to a lighting system, in particular in the form of an aircraft interior lighting system and preferably designed to carry out the method according to one of the preceding claims, which system is characterized by a plurality of such light segments.

In one preferred refinement of the invention, the plurality of such light segments are connected via a or the serial data connection which is also coupled to a control device for data-processing purposes, the control device being in the form of a master unit which can transmit status change information via the data connection.

In particular, the serial data connection assumes a dual function since it firstly transmits the status change information, in particular the address information, when installing or initializing the lighting system and secondly can selectively address the light segments via the address during subsequent operation and can transmit operating parameters or operating states to the light segments. The serial data connection is preferably in the form of a half-duplex connection, with the result that data can be transferred from the master unit to the light segments and vice versa.

In one possible refinement of the invention, the method can also be referred to as a tokening method, in which case only that slave unit which is intended to receive the status change information receives the token.

### BRIEF DESCRIPTION OF THE DRAWINGS

Further features, advantages and effects of the invention emerge from the following description of a preferred exemplary embodiment and the accompanying figures, in which:

FIG. 1 shows a schematic block diagram of a lighting system as an exemplary embodiment of the invention;

FIG. 2 shows a flowchart for visualizing an exemplary embodiment of the method according to the invention.

### DETAILED DESCRIPTION OF THE INVENTION

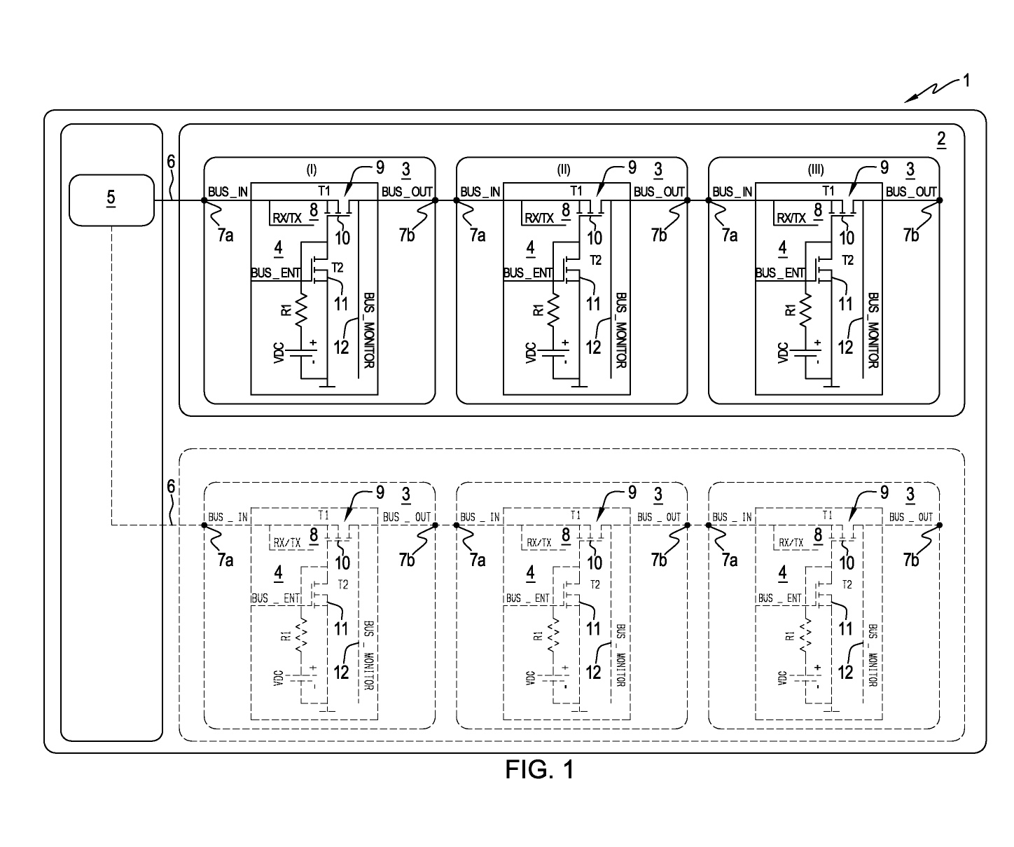

FIG. 1 shows a schematic block diagram of a lighting system 1 as is used, for example, as a cabin lighting system in civil aircraft. The lighting system 1 has side wall and ceiling strip lights, for example.

These strip lights are constructed from a multiplicity of light modules 2, each light module 2 being assigned a plurality of light segments 3. Each light segment 3 has a plurality of LEDs which—depending on the equipment—are only monochromatic or else polychromatic. For example, the light segments 3 have LEDs with the colours red, green, blue and white, with the result that the emitted light can be varied in terms of the colour locus and brightness. The light segments 3 each have more than 10, preferably more than 50, in particular more than 100, LEDs, for example.

Each light segment 3 comprises a slave unit 4 which, on the one hand, controls the LEDs and, on the other hand, communicates with a master unit 5 using signalling. For example, the slave unit 4 may comprise a microcontroller.

The slave units 4 of the light segments 3 are connected via a common data bus 6 which, starting from the master unit 5 within one of the light modules 2, connects a plurality of light segments 3 to one another. In terms of the architecture, the master unit as the bus master can drive a plurality of light modules 2 with a plurality of data buses 6. It is also possible for a plurality of data buses 6 to be provided inside a light module 2, which data buses then each connect a plurality of light segments 3 for data-processing purposes.

The data bus 6 is in the form of a serial data bus which serially connects the light segments 3. Data can be transferred from the master unit 5 to the slave units 4 and vice versa (half-duplex). For coupling, each light segment 3 has an input interface 7a and an output interface 7b, the output interface 7b having a data-processing connection to the input interface 7a of the adjacent light segment 3 between the light segments 3 via the data bus 6.

In terms of signalling, the slave units 4 have a communication device 8 (RX/TX) with a receiver Rx and a transmitter Tx as well as an interruption device 9, which is arranged downstream of the communication device 8 in terms of signalling, between the input interface 7a and the output interface 7b. In this example, the interruption device 9 comprises a MOSFET transistor 10 which is designed to interrupt the serial data bus 6 inside the light segment 2. A transistor circuit 11 (T2) which can be activated and deactivated via an internal signal Bus_EN is provided for the purpose of driving the MOSFET transistor 10. The slave unit 4 is thus designed to interrupt the serial data bus 6 via the interruption device 9. The slave unit 4 also comprises a monitor device 12 which is arranged downstream of the interruption device 9 in terms of signalling and checks the connection to the master unit 5 and thus simultaneously checks the status of the interruption device 9.

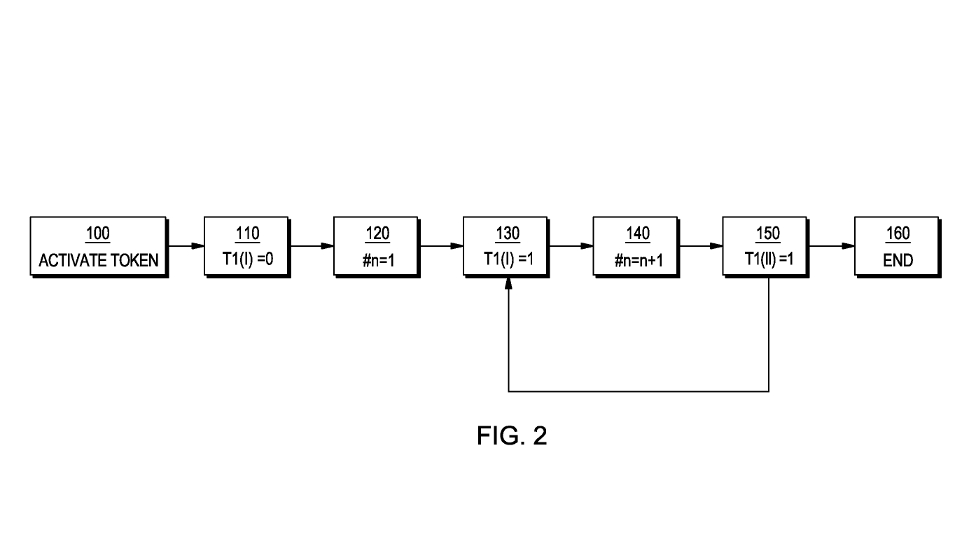

During standard operation, the interruption devices 9 are closed and messages (broadcast message format) thus pass from the master unit 5 to all light segments 3 of the data bus 6. In order to issue a respective specific command (unicast) to light segments 3, each light segment 3 must have a valid address (ID, identifier). This address can be assigned to the light segment 3 in a soft-coded manner, as is explained using the flowchart in FIG. 2:

In order to change or initialize the addresses in the light segments 3 for the first time, a broadcast message is transmitted to all light segments 3 in a first step 100. The broadcast message contains the instruction to interrupt the data bus 6 in each light segment 3 using the interruption device 9 (activate token).

In response to the instruction, all light segments 3 open their interruption device 9 (T1=0) in a step 110.

In a step 120, the master unit 5 sets an address to #n=1 and transmits a broadcast message, with the command to set the internal address to #n=1, via the data bus 6. After the data bus 6 has been interrupted by the interruption devices 9, only the first light segment 3 (I) of the serial data bus 6 can receive the command and assigns the value 1 to its address (identifier). The light segment 3 then transmits a confirmation signal to the master unit 5 (acknowledge to master) and closes the interruption device 9 in a step 130.

In a step 140, the master unit 5 now increases the address by 1 to #n=n+1 and again transmits a broadcast message with the command to set the address to #n=n+1. Since the first light segment 3 has already received an address and the interruption device of the first segment 3 (I) has been closed, the following light segment 3 (II) can now receive the message and assigns the value 2, predefined by the master unit 5, to its address.

In a similar manner to the first light segment 3 (I), the following light segment 3 (II) also transmits the confirmation signal and closes its interruption device 9 in a step 150.

The steps 130 to 150 are repeated until all of the light segments 3 have received an address. The end of a chain or of the serial data bus 6 is defined by the absence of the confirmation signal since all light segments 3 have now been identified and addressed. This is the abort criterion for the master unit 5 in a step 160. Optionally, the operation can also be repeated several times but without increasing the address #n further in order to improve the detection reliability.

### LIST OF REFERENCE SYMBOLS

1 Lighting system
2 Light module
3 Light segment
4 Slave unit
5 Master unit
6 Data bus
7a Input interface
7b Output interface
8 Communication device
9 Interruption device
10 MOSFET transistor
11 Transistor circuit
12 Monitor device

What is claimed is:

1. A method for changing the status of light segments in a lighting system,
the light segments being connected to one another via a serial data connection,
the status change comprising the following steps:
the serial data connection is interrupted in or at the light segments;
an item of status change information is transmitted to a first light segment via the serial data connection;
the serial data connection is restored in the first light segment; and
an item of status change information is transmitted to a second light segment via the serial data connection.

2. The method for changing the status according to claim 1,
wherein
the status change involves addressing the light segments and comprises the following steps:
an item of address information is transmitted to the first light segment; and
a first address is set in the first light segment.

3. The method for changing the status according to claim 1, wherein
the first light segment outputs an item of confirmation information after the status change information has been received.

4. The method for changing the status according to claim 1,
wherein
the method is ended as soon as no confirmation information is returned after the status change information has been transmitted.

5. A light segment comprising
a slave unit which can be assigned an item of status information,
having an interface for looping through a serial data connection,
and
an interruption device for interrupting the serial data connection, the slave unit being designed to switch the interruption device.

6. The light segment according to claim 5 wherein said light segment is in the form of an aircraft interior lighting system.

7. The light segment according to claim 5,
wherein
the status information represents an address of the light segment.

8. The light segment according to claim 7, wherein said address is an ID or an identifier.

9. The light segment according to claim 5,
wherein
the interruption device is in the form of a switching element.

10. The light segment according to claim 9, wherein said switching element is in the form of a MOSFET switch.

11. The light segment according to claim 5 further comprising a monitor device which is designed to check the data connection, the monitor device being arranged downstream of the interruption device in terms of signalling.

12. A lighting system, comprising at least two light segments according to claim 5.

13. The lighting system according to claim 9, comprising a plurality of such light segments, having a serial data connection, which connects the plurality of light segments, and having a control device, the control device being in the form of a master unit and being designed to transmit status change information via the data connection.

14. The lighting system according to claim 12, wherein said lighting system is in the form of an aircraft interior lighting system.
